(19) United States
(12) Patent Application Publication
(10) Pub. No.: US 2009/0267385 A1
(43) Pub. Date: Oct. 29, 2009

(54) Platform for a vehicle-mounted box

(76) Inventor: John E. Shackleford, Chattanooga, TN (US)

Correspondence Address: KNOX PATENTS, P.O. BOX 30034, KNOXVILLE, TN, 37930-0034, US

(21) Appl. No.: 12/429,801

(22) Filed: Apr. 24, 2009

Related U.S. Application Data
(60) Provisional application No. 61/047,564, filed on Apr. 24, 2008.

(51) Int. Cl. B60R 3/00; A47B 96/06

(52) U.S. Cl. 296/193.05; 248/201; 248/219.3

(57) ABSTRACT

A platform for climbing and/or standing on a vehicle-mounted box by a person having a greater than average girth is provided. In one embodiment, the platform includes a tread, an arm, and a bracket. The tread has a surface area sufficiently sized so that a person of greater than average girth has room to place his feet on the tread while climbing and/or standing on a vehicle-mounted box. The arm is attached to the tread. The bracket pivotally secures the arm such that the attached tread pivots about the bracket. The bracket tightly holds the tread to provide stability during transportation in a storage position and during use in a use position. In another embodiment, the platform also includes a tube. The tube includes holes spaced apart along its length. The location of the bracket is vertically adjustable along the tube.

### CROSS-REFERENCE TO RELATED APPLICATIONS

This application claims the benefit of U.S. Provisional Application No. 61/047,564, filed Apr. 24, 2008.

### STATEMENT REGARDING FEDERALLY SPONSORED RESEARCH OR DEVELOPMENT

Not Applicable

### BACKGROUND OF THE INVENTION

1. Field of Invention

This invention pertains to a platform. More particularly, this invention pertains to a platform for use by persons of greater than average girth to climb and/or stand on a vehicle-mounted box, or truck box.

2. Description of the Related Art

Heavy equipment typically includes catwalks, platforms, and ladders to allow operators and others access to the equipment. The type, size, and configuration of heavy equipment varies based on the application and use of the equipment. For example, U.S. Pat. No. 6,209,682, titled “Ladder assembly for track-type tractors,” discloses a ladder support structure that extends over a track of the tractor and has a ladder pivotally attached to a distal end of the ladder support structure that provides steps over a push arm and a tilt cylinder of the tractor. In this way the operator is able to access the operator station of a large track-type tractor without resorting to the operator climbing on the push arms, tilt cylinders, radiator, radiator guard, track, hood, and engine enclosures.

Other types of heavy equipment have other needs. For example, U.S. Pat. No. 6,601,220, titled “Retractable ladder,” discloses a ladder with a parallelogram-type linkage that allows the ladder to assume two fixed positions. Other ladders and access systems are collapsible or otherwise fold. For example, U.S. Pat. No. 3,989,122, titled “Folding ladder for truck mounted loader,” discloses a ladder having one standard attached to the truck and the other standard and rungs are pivotally connected to each other and to the inner standard whereby the outer standard can be pivoted upwardly against the inner standard to substantially reduce the width of the ladder to a position within the acceptable traveling width of the truck.

It is also known to use catwalks that allow an individual to easily access the interior of a truck box, such as disclosed in U.S. Pat. No. 6,431,093, titled “Truck catwalk system.” The catwalk assembly includes a platform, a ladder, and other components configured to fold the platform when not in use. Ladders are also pivotally attached to truck boxes to allow the ladder to remain vertical regardless of the inclination of the truck box, such as disclosed in U.S. Pat. No. 4,482,029, titled “Truck ladder.”

In addition to access systems, various smaller steps and platforms that provide specific access to equipment are known. For example, U.S. Pat. No. 5,456,479, titled “Truck access step,” discloses a compactable access step for use with vehicles to make it easier for a person to reach into the engine compartment and radiator compartment of the vehicle. The access step is removable and foldable for storage. U.S. Pat. No. 4,930,797, titled “Safety step system,” discloses a fold-out safety step system for use in a passenger van having a side door. The safety step is pivotally attached to the floor of the van to allow the step to be folded out and down when the side door is open.

### BRIEF SUMMARY OF THE INVENTION

I have observed that persons of greater than average girth, hereinafter large persons, do not have a safe and convenient way to climb and/or stand on a truck box. Safely climbing and/or standing on a truck box by a large person is made possible by a platform attached to the truck box. In one embodiment, the platform includes a safety grating tread, or tread, an arm, and a bracket. In another embodiment, the platform also includes a rail, or tube, to adjust the vertical location of the platform. The tread provides a surface for standing. A person who is climbing and/or standing on a truck box will likely have their body pressed against the truck box. When the body of a large person presses against the truck box while climbing and/or standing, his feet will tend to kick out away from the side of the box.

The tread provides a secure foothold even when leaning into the truck box. When standing against the truck box, the person whose feet are closer to the truck box experiences a greater force against his body. The force against the body tends to create an unsafe condition where the feet kick out away from the truck box. The large person will experience greater force against his body than a thin person when standing the same distance away from the truck box. A large person, therefore, should stand further away from the truck box to avoid the unsafe condition.

To accommodate the large person, the tread has a width such that it extends a specified distance away from the truck box. Accordingly, a large person is able to maintain secure contact between the tread and his shoes while climbing and/or standing on the truck box.

Persons who must climb and/or stand on a truck box, such as dump truck operators who transport asphalt, often have debris such as tar and rocks on the bottom of their shoes. The debris creates a hazardous condition when climbing a truck box. I have observed that this hazardous condition is particularly troublesome for large persons. The tread has a large enough surface area for multiple foot placements such that the user can change positions when the tread becomes clogged or otherwise looses its ability to provide a secure foothold.

Having a safe way to climb and/or stand on a truck box is not sufficient if the user fails to use the apparatus because it is too complicated or cumbersome. Also, there are width limits imposed on vehicles that use our nation's roadways. In order to provide a convenient way to climb and/or stand on a truck box without requiring removal of the platform before driving on a roadway, I have provided a platform with a pivotally attached tread. The platform has an arm that is attached to the tread. The arm is pivotally attached to the bracket. The bracket provides a tight pivotal movement to the arm. The tread pivots about the bracket on the arm. When the platform is not in use, the tread is pivoted into the storage position where the tread is substantially perpendicular to the ground. When the operator must climb the truck box, the tread is pivoted approximately 90 degrees from the storage position to a use position.

A large person has little visual assurance of his footing. If the tread would accidentally pivot to the storage position, a large person may not be able to visually detect that the tread was no longer available for standing. The tread is tightly hinged to hold it securely in any given position. Being tightly hinged, the tread resists being accidentally kicked to the storage position while in use. The tightly held tread also resists being bumped open while driving on rough terrain, thus eliminating the need for additional hardware such as latches or springs to hold the tread in the storage or use position.

In one embodiment, the platform includes a rail, or tube, such that the vertical location of the tread is adjustable. An adjustable height makes it convenient for a wider range of users. In another embodiment, a system of platforms is installed. In one such embodiment, the system of platforms includes a pair of platforms having an upper and a lower platform. In one embodiment, the lower platform is longer than the upper platform. The lower platform provides access to the upper platform. The tread of the upper platform is pivoted to the use position as needed by the user.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a platform installed on a vehicle-mounted box;

FIG. 2 is a perspective view depicting the use of the platform shown in FIG. 1;

FIG. 3 is a perspective view of one embodiment of a platform for a vehicle-mounted box;

FIG. 4 is a perspective view of one embodiment of a bracket used on the platform shown in FIG. 3;

FIG. 5 is a perspective view of another embodiment of a bracket used on one embodiment of a platform for a vehicle-mounted box; and

FIG. 6 is a side view of one embodiment of a system of platforms installed on a vehicle-mounted box.

### DETAILED DESCRIPTION OF THE INVENTION

An apparatus for safely climbing and/or standing on a vehicle-mounted box, or truck box 102, by a person of greater than average girth, or a large person, 202 is disclosed. Currently, large persons 202 do not have a safe way to climb and/or stand on a truck box 102.

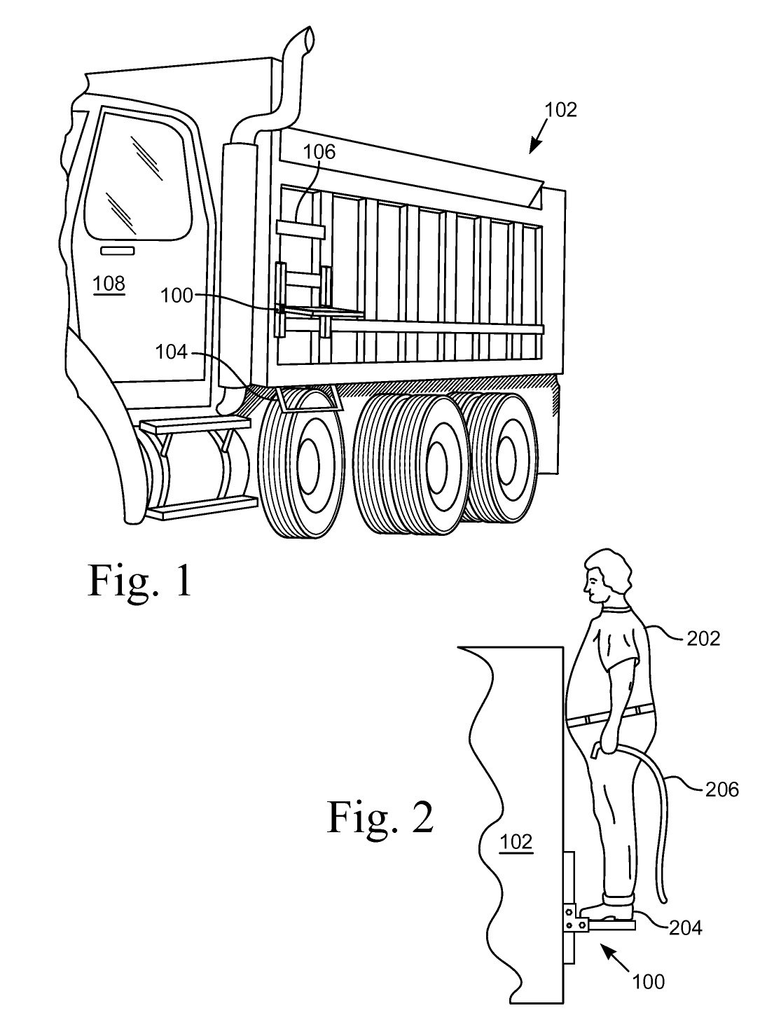

FIG. 1 illustrates one embodiment of a platform 100 installed on a truck box 102. FIG. 2 illustrates the use of the platform 100 shown in FIG. 1. The vehicle 108 in FIG. 1 includes a step 104 extending below the truck box 102 and a number of rungs 106 spaced apart one above the other leading to the top of the truck box 102. The rungs 106 are smooth thin strips of metal. A large person 202 has a difficult time using the rungs 106 to ascend and/or stand on the truck box 102.

An operator 202 of a vehicle 108 having a truck box 102 often needs to climb the truck box 102 or stand at a certain height relative to the truck box 102. For example, a truck box 102 carrying asphalt will not empty completely without the operator 202 adding a release agent. If no release agent is applied, the operator 202 must climb into the truck box 102 to clear out the remaining asphalt by hand. The release agent is generally supplied through a hose 206. Climbing the truck box 102 and standing such that the operator 202 can apply a release agent is a daunting task for many. For those of us who have a greater than average girth, it is, indeed, a very difficult task that is replete with hazards. For example, the illustrated person 202 is shown with a greater than average girth, that is, the waist or medial portion of the person 202 is larger than average, which causes the person's belly to protrude toward the front.

Persons 202 who need to climb a truck box 102, such as dump truck operators who transport asphalt, often have debris such as tar and rocks on the bottom of their shoes 204. The debris-coated shoes 204 create a hazardous condition when climbing the rungs 106 of a truck box 102. A platform 100 provides a surface upon which a large person 202 may safely climb and/or stand on the truck box 102.

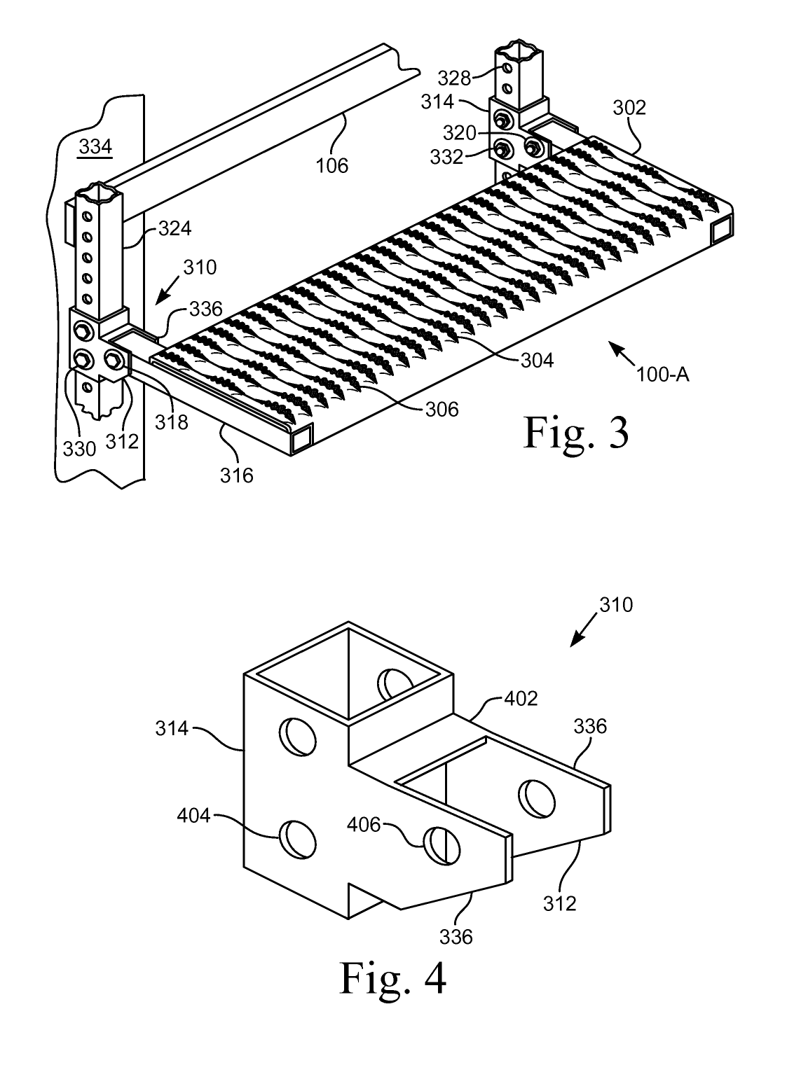

FIG. 3 illustrates one embodiment of a platform 100-A for a truck box 102. The platform 100-A is attached to the truck box 102. In one embodiment, the platform 100-A includes a safety grating tread, or tread 302, one or more arms 316, and corresponding brackets 310. In the illustrated embodiment, the platform 100-A also includes rails, or tubes, 324 that allow adjustment of the vertical location of the platform 100-A. The rails 324 are substantially vertically oriented when the vehicle 108 is level.

When standing against the truck box 102 on a rung 106 or a platform 100-A, the person 202 must press his body against the truck box 102, which results in the person 202 desiring to step away from the truck box 102. The resulting force against the body tends to create an unsafe condition where the feet are forced away from the truck box 102. The large person 202 will experience greater force against his body than a thin person when standing the same distance away from the truck box 102. A large person 202, therefore, should stand further away from the truck box 102 to avoid the unsafe condition. The platform 100-A provides a tread 302 that extends away from the truck box 102 to where the feet of the large person 202 fully contact the tread 302. The size and location of the tread 302 prevents the feet from being forced away from the truck box 102. For example, between an edge proximate the truck box 102 and a distal edge of the tread 302 is a distance of at least eight inches, which is typically sufficient to accommodate a shoe of a person 202 standing on the tread 302 and facing the truck box 102. Greater dimensions aid in the stability of the person 202 and allows the person 202 to move his feet while being able to support himself on the tread 302.

The tread 302 includes openings 304 and serrations 306. The openings 304 are sized to allow debris that is found on debris coated shoes 204 to pass through the openings 304. The serrations 306 are large enough to provide traction to debris coated shoes 204. The debris includes such materials as tar, asphalt, gravel, and other materials that cause an insecure footing. The combination of openings 304 and serrations 306 provide a secure foothold even when a large person 202 is required to lean against the truck box 102.

Oftentimes, the operator 202 of a vehicle will be required to climb and/or stand on a truck box 102 for an extended period of time or many times over the course of a day. The tread 302 has a surface 308 large enough to provide multiple foot placements such that the operator 202 can change positions when the openings 304 and serrations 306 become clogged or otherwise loose their ability to provide a secure foothold.

The tread 302 is attached to the arm 316 such that the longitudinal axis of the tread 302 is perpendicular to the longitudinal axis of the arm 316. The arm 316 is an elongated member that is pivotally attached at one end to the bracket 310. The tread 302 pivots with the arm 316 about the bracket 310. When the platform 100-A is not in use, the tread 302 is pivoted into the storage position where the tread 302 is substantially perpendicular to the ground. In the storage position, the tread 302 extends the least possible distance away from the truck box 102. When the operator must climb the truck box 102, the tread 302 is pivoted approximately 90 degrees from the storage position to a use position. The use position provides the maximum support to the user for climbing and/or standing on the truck box 102.

FIG. 4 illustrates one embodiment of a bracket 310 used on the platform 100-A shown in FIG. 3. The bracket 310 tightly holds the arm 316 in a given position. The bracket 310 includes a clamp end 312, a mount end 314 and a ledge 402.

The clamp end 312 includes two parallel plates 336 located opposite each other. The arm 316 is sized to fit between the two parallel plates 336. The clamp end 312 provides for the pivotal mounting of the arm 316 which is attached to the tread 302. In the illustrated embodiment, the arm 316 is held tightly in place by a clamping bolt 318 and a clamping nut 320. The clamping bolt 318 passes through a hole 406 in each of the two parallel plates 336 and through a hole in the arm 316. The two parallel plates 336 are pressed tightly against the arm 316 by the clamping nut 320 and the clamping bolt 318. The arm 316 and the attached tread 302 pivot about the bolt 318.

The clamp end 312 holds the arm 316 tightly, but allows pivotal movement when sufficient force is applied, that force being greater than that caused by gravity due to the weight of the tread 302 and arms 316. By holding the arm 316 tightly, the tread 302 resists being accidentally kicked to the storage position while in use. The tightly held arm 316 also holds the tread 302 in the storage position during transit over rough terrain. The tightly held arm 316 eliminates the need for additional securing hardware such as latches and springs to hold the tread 302 in the storage or use position. Because the tread 302 is held tightly while pivoted to position, it is possible to set the angle of the tread 302 anywhere within its range of motion.

In the illustrated embodiment, the mount end 314 of the bracket 310 is configured to attach to a tube 324. The bracket 310 is mounted on the tube 324 such that the location of the tread 302 is vertically adjustable. The location of the tread 302 is made adjustable by a series of locating holes 328 on the tube 324. The locating holes 328 register with the mounting holes 404 on the mount end 314 of the bracket 310. A locating bolt 330 passes through the locating hole 328 and the mounting hole 404 to secure the tread 302 at the desired location. The locating nut 332 holds the locating bolt 330 in position. In other embodiments, cotter pins, clevis pins, detent pins, cotterless clevis pins, headless pins, or other fasteners are used to hold the tread 302 in the desired location.

Movement of the bracket 310 along the tube 324 is made possible, in the illustrated embodiment, by attaching the tube 324 to the rungs 106. The rungs 106 separate the tube 324 from the truck box wall 334 to provide clearance for the bracket 310, which slides along the tube 324. Those skilled in the art will recognize that other ways to separate the tube 324 from the truck box wall 334 can be used without departing from the spirit and scope of the present invention.

The bracket 310 includes a ledge, or stop, 402 located between the clamp end 312 and the mount end 314. The ledge 402 provides a stop for the arm 316. The arm 316 is attached to the tread 302. When the tread 302 pivots into the use position, the top surface of the arm 316 contacts the bottom surface of the ledge 402. The ledge 402 prevents the arm 316 from further pivotal movement. By stopping the arm 316, the ledge 402 supports the tread 302 bearing the weight of a large person 202 while in the use position.

A large person 202 has little visual assurance of his footing. If the tread 302 would accidentally pivot from the use position to the storage position, a large person 202 may not be able to visually detect its absence. The tread 302 is tightly held in a given position while permitting the tread 302 to pivot between the use position and the storage position.

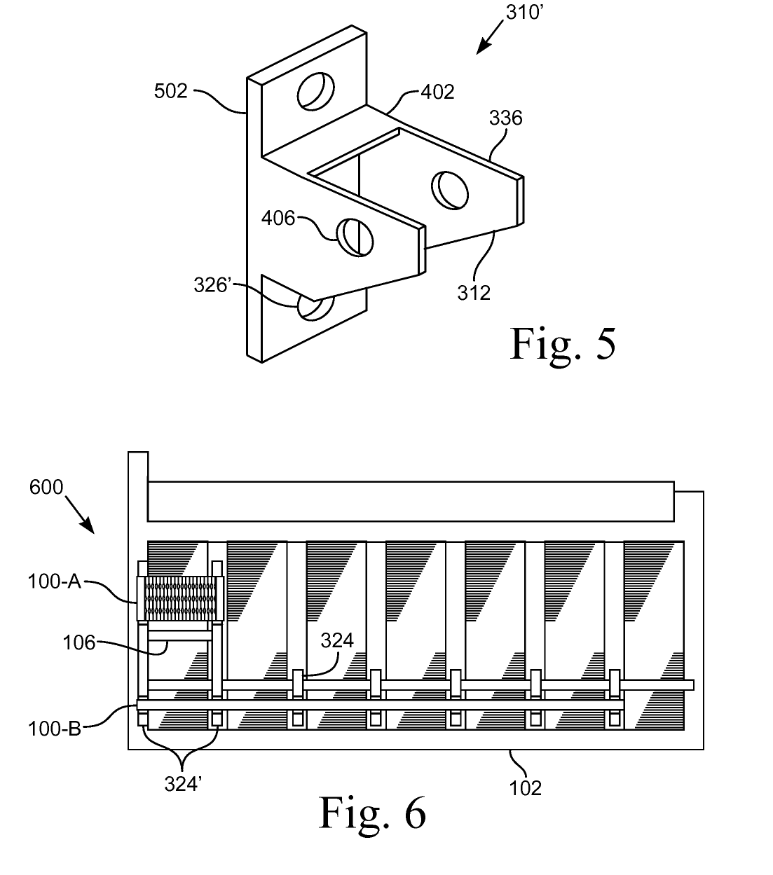

FIG. 5 illustrates another embodiment of a bracket 310′ used on one embodiment of a platform 100 for a truck box 102. The bracket 310′ includes a mount end 502 that is configured to mount directly onto a surface, such as a truck box 102. The bracket 310′ also includes the ledge 402 and the clamp end 312 as shown in FIG. 3. The mounting hole 326′ is oriented for mounting directly to a surface. The mounting hole 326′ is dimensioned to receive a bolt. In other embodiments, the mount end 502 is welded or otherwise attached to the truck box 102.

FIG. 6 illustrates one embodiment of a system of platforms 600 installed on a truck box 102. The system of platforms 600 includes an upper platform 100-A and a lower platform 100-B. In the illustrated embodiment, the lower platform 100-B is longer than the upper platform 100-A. In that way, the lower platform 100-B provides convenient access to the upper platform 100-A. The tubes 324′ that hold both the upper platform 100-A and the lower platform 100-B are longer than the tubes 324 supporting only the lower platform 100-B. In such a configuration, the step 100-A and the platform 100-B are vertically offset, thereby allowing the person 202 to be supported at different elevations alongside the vehicle box 102.

The platform 100 includes various functions. The function of supporting a large person 202 while climbing and/or standing on a truck box 102 is implemented, in one embodiment, by a tightly hinged tread 302 that is dimensioned and configured to extend a distance away from the truck box 102 such that the feet of the large person 202 are completely in contact with the tread 302.

The function of providing a foothold to a large person 202 climbing and/or standing on a truck box 102 while wearing debris-coated shoes 204 is implemented, in one embodiment, by a platform 100 with a safety grating tread 302 having a large enough surface to permit the large person 202 to change positions when the tread becomes clogged or otherwise looses its ability to provide a secure foothold.

The function of holding a pivotally mounted tread 302 in a storage position during transit over a rough terrain is implemented, in one embodiment, by a clamp end 312 with holes that register with holes in an arm 316 attached to a tread 302 where a clamping bolt 318 passes through the holes and is tightly secured by a clamping nut 320. The tread 302 pivots about the clamping bolt 318.

The function of pivoting a tread 302 is implemented, in one embodiment, by a clamp end 312. The clamp end 312 provides for pivoting motion about a clamping bolt 318.

The function of fixedly positioning a tread 302 is implemented, in one embodiment, by the mount end 314 of a bracket 310, which is adapted to receive a tube 324. One end of the arm 316 is attached to the mount end 314. The other end of the arm 316 is attached to a tread 302. A locating bolt 330 is removably inserted into registered through-holes of the mount end 314 and the tube 324 to fix the mount end 314 at a location on the tube 324, thereby fixing the position of the tread 302 along the tube 324.

From the foregoing description, it will be recognized by those skilled in the art that a platform 100 for climbing and/or standing on a truck box 102 by a large person 202 has been provided. The platform 100 includes a tread 302, an arm 316, and a bracket 310. The tread 302 has a large surface area extending away from the truck box 102 so that a large person 202 has room to stand against the truck box 102 without forcing his feet off of the tread 302. The tread 302 is sufficiently large that a large person 202 can shift his footing when portions of the tread 302 become filled with debris or otherwise becomes ineffective in providing a secure foothold.

The tread 302 is pivotally supported so that it has a storage position with a narrow profile and a use position, pivoted approximately 90 degrees of the storage position. The storage position is such that the tread 302 is substantially parallel with the rails 324. The use position is such that the surface of the tread 302 is substantially perpendicular with the rails 324. The tread 302 is tightly hinged so that it will not significantly change position during travel over rough terrain or when accidentally kicked while in use.

The location of the tread 302 is adjustable. In one embodiment, the platform 100 includes a tube 324. The mount end 314 of the bracket 310 is adjustably mounted on the tube 324. A locating bolt 330 and a locating nut 332 secure the platform 100 in pre-determined locations along the tube 324.

An apparatus for standing and/or climbing on a vehicle-mounted box by a person of greater than average girth, said apparatus comprising a tread, said tread having a large surface area; an arm, said arm attached to said tread, said arm having a distal end, said arm having an arm aperture passing through said distal end; a support, said support being an elongated member, said support being fixed to the vehicle-mounted box, said support being spaced a distance away from the vehicle-mounted box, said support having at least one support aperture passing through said support; and a bracket, said bracket including a mount end, said mount end being dimensioned and configured to received said support, said mount end having a mount aperture, said mount aperture being located such that said mount aperture registers with one of said at least one support aperture; a connecting member, said connecting member passing through said mount aperture and said support aperture such that said mount end is secured on said support, such that said mount end a clamp end, said clamp end being pivotally disposed on said distal end of said arm, said clamp end having a first wall and a second wall; said first wall having a first aperture, said second wall having a second aperture, said first aperture coaxial with said second aperture, said first wall and said second wall disposed on opposite sides of said arm such that said arm aperture registers with said first aperture and said second aperture; a bolt, said bolt passing through said arm aperture and said first aperture and said second aperture, said bolt pivotally connecting said arm to said clamp; and a ledge, said ledge being affixed to said bracket; said ledge holding said tread in a substantially horizontal orientation, whereby said clamp end is adjustably secured to said arm, such that said arm is held tightly in a pre-set position.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for standing and/or climbing on a vehicle-mounted box by a person of greater than average girth, said apparatus comprising:
a step having a first edge and a second edge and a substantially planar surface therebetween;
a pair of arms extending from said first edge and substantially coplanar with said planar surface;
a pair of brackets, each one of said pair of brackets having a pivotal connection with a corresponding one of said pair of arms; and
a pair of rails attached to a vehicle, said pair of rails having a substantially vertical orientation when said vehicle is level, each one of said pair of rails having a plurality of rail apertures, said pair of brackets having more than one position vertically wherein a bracket aperture is in register with one of said plurality of rail apertures and a fastener engages said bracket aperture and said one of said plurality of rail apertures,
said pair of arms movable between a first position and a second position, said first position being with said pair of arms substantially perpendicular to said pair of rails, said second position being with said pair of arms substantially parallel to said pair of rails, each of said pivotal connections having a coefficient of friction sufficient to secure said pair of arms and said step from moving between said first and second positions due to a gravitational force.

2. The apparatus of claim 1 wherein each one of said pivotal connections includes a clamping mechanism that clamps each one of said pair of arms and a corresponding one of said pair of brackets together.

3. The apparatus of claim 1 wherein each one of said pivotal connections includes a pair of plates that clamp each one of said pair of arms and a corresponding one of said pair of brackets together.

4. The apparatus of claim 1 wherein said first edge of said step is a selected distance from said pair of rails such that the person of greater than average girth is able to stand upright on said step.

5. The apparatus of claim 1 further including a platform, said platform pivotally attached to at least one of said pair of rails, said platform movable between a first platform position and a second platform position, said first platform position being with said platform substantially perpendicular to said pair of rails, said second platform position being with said platform substantially parallel to said pair of rails, said platform requiring a force greater than that due to gravity to move said platform between said first and second platform positions.

6. The apparatus of claim 1 wherein each one of said pair of brackets slideably engages a corresponding one of said pair of rails.

7. The apparatus of claim 1 wherein said pair of rails are attached to said vehicle such that each one of said pair of rails is separated from said vehicle with a gap, said gap allowing a corresponding one of said pair of brackets to slideably move vertically a selected distance along a length of said each one of said pair of rails.

8. The apparatus of claim 1 wherein said substantially planar surface of said step includes protrusions configured to provide a secure footing to the person.

9. The apparatus of claim 1 wherein said first and second edges are separated by a distance of at least 8 inches, whereby said planar surface of said step is dimensioned to accommodate a foot of the person.

10. An apparatus for standing and/or climbing on a vehicle by a person of greater than average girth, said apparatus comprising:
a tread having a substantially planar surface;
an arm attached to said tread, said arm having a distal end, said arm having an arm aperture passing through said distal end;
a support, said support being an elongated member, said support configured to be fixed to the vehicle-mounted box in a substantially vertical orientation, said support configured to be spaced a selected distance away from the vehicle-mounted box, said support having at least one support aperture passing through said support; and
a bracket, said bracket including:
a mount end, said mount end engaging said support, said mount end having a mount aperture, said mount aperture being located such that said mount aperture registers with one of said at least one support aperture, said mount end secured to said support by a connecting member engaging said mount aperture and said support aperture;
a clamp end, said clamp end being pivotally disposed on said distal end of said arm, said clamp end having a first wall and a second wall; said first wall having a first aperture, said second wall having a second aperture, said first aperture coaxial with said second aperture, said first wall and said second wall disposed on opposite sides of said arm such that said arm aperture registers with said first aperture and said second aperture, said arm pivotally connected to said clamp end by a fastener engaging said arm aperture, said first aperture, and said second aperture; and
a stop that engages said arm when said arm is in a substantially horizontal position relative to the vehicle-mounted box.

11. The apparatus of claim 10 wherein said tread is movable between a first position and a second position, said first position being with said tread substantially perpendicular to said support, said second position being with said tread substantially parallel to said support, said tread requiring a force greater than that due to gravity to move said tread between said first and second positions.

12. The apparatus of claim 10 wherein said first edge of said tread is a selected distance from said support such that the person of greater than average girth is able to stand upright on said tread.

13. The apparatus of claim 10 further including a platform, said platform pivotally attached to said support, said platform movable between a first platform position and a second platform position, said first platform position being with said platform substantially perpendicular to said support, said second platform position being with said platform substantially parallel to said support, said platform requiring a force greater than that due to gravity to move said platform between said first and second platform positions.

14. The apparatus of claim 10 wherein said bracket slideably engages said support.

15. The apparatus of claim 10 wherein said substantially planar surface of said tread includes protrusions configured to provide a secure footing to the person.

16. The apparatus of claim 10 wherein said planar surface of said tread has a length extending away from said support of at least 8 inches, whereby said planar surface of said tread is dimensioned to accommodate a foot of the person.

17. An apparatus for standing and/or climbing on a vehicle by a person of greater than average girth, said apparatus comprising:
a step having a first edge and a second edge and a surface therebetween, said surface configured for the person to stand with at least one foot in contact with said surface;
a first support member and a second support member, said first and second support members configured to be attached to a vehicle with a substantially vertical orientation;
a first bracket and a second bracket, said first bracket attachable to said first support member at one of a plurality of selected positions along a length of said first support member, said second bracket attachable to said second support member at one of a plurality of selected positions along a length of said second support member; and
a first arm and a second arm extending from said step, a distal end of said first arm pivotally connected to said first bracket, a distal end of said second arm pivotally connected to said second bracket,
said step being movable between a first position and a second position relative to said first and second support members, said surface of said step substantially perpendicular to said first and second support members when said step is in said first position, each one of said first and second brackets including a stop that supports a corresponding one of said first and second arms in said first position, said surface of said step substantially parallel to said first and second support members when said step is in said second position.

18. The apparatus of claim 17 wherein said first and second edges are separated by a distance of at least 8 inches, whereby said surface of said step is dimensioned to accommodate a foot of the person when a ventral surface of said person is proximate said first and second support members.

19. The apparatus of claim 17 wherein a first pivotal connection between said first arm and said first bracket has a coefficient of friction and a second pivotal connection between said second arm and said second bracket has a coefficient of friction sufficient to retain said step at a selected position against a force of gravity.

20. The apparatus of claim 17 including a platform vertically offset from said step, said platform moving between a first platform position and a second platform position, said platform substantially perpendicular to said first and second support members when said platform is in said first platform position, said platform substantially parallel to said first and second support members when said platform is in said second platform position, said platform having at least one pivotal connection with a coefficient of friction sufficient to retain said platform at a selected position against a force of gravity.
